(19) United States
(12) Patent Application Publication
(10) Pub. No.: US 2010/0177345 A1
(43) Pub. Date: Jul. 15, 2010

(54) IMAGE FORMING APPARATUS AND PRINT CONTROL METHOD

(75) Inventor: Hiroshi Watanabe, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/685,059

(22) Filed: Jan. 11, 2010

Related U.S. Application Data
(60) Provisional application No. 61/144,987, filed on Jan. 15, 2009.

(51) Int. Cl. G06F 3/12

(52) U.S. Cl. 358/1.15

(57) ABSTRACT

An image forming apparatus stores, in a memory, print jobs and execution sequences for forming images of the print jobs, forms the images of the print jobs according to the execution sequences stored by the memory, measures execution time from the start of image formation for a print job being subjected to the image formation, determines whether plural print jobs are stored by the memory, determines, if plural print jobs are stored at least by the memory, whether the measured execution time of the print job being subjected to the image formation reaches designated execution time, and suspends, after the execution time reaches the designated execution time, the printing job being subjected to the image formation and executes a print job of the next execution sequence stored by the memory.

### CROSS-REFERENCE TO RELATED APPLICATION

This application claims the benefit of U.S. Provisional Application No. 61/144,987, filed Jan. 15, 2009.

### TECHNICAL FIELD

The present invention relates to image forming apparatuses such as a digital multi function peripheral, a coping machine, and a network printer configured to accumulate print processing as jobs and sequentially execute the accumulated jobs and a print control method for the image forming apparatuses.

### BACKGROUND

In the past, in some case, an image forming apparatus such as a digital multi function peripheral continuously receives plural print requests using a network print function or the like. Some image forming apparatus in the past manages plural print requests as print jobs, respectively. For example, JP-A-2002-91727 discloses a technique for predicting time required for plural print jobs and performing interruption or the like of a print job on the basis of the prediction.

However, a printing control apparatus disclosed in JP-A-2002-91727 compares remaining estimated printing time for a print job being executed and printing predicted time for print jobs queued for execution and determines whether interruption should be performed. In the printing control apparatus disclosed in JP-A-2002-91727, even if a print job with short printing time is being executed, the next print job sometimes interrupts the print job being executed.

### SUMMARY

It is an object of an aspect of the present invention to provide an image forming apparatus and a print control method that can efficiently execute plural kinds of print processing.

According to an aspect of the present invention, there is provided an image forming apparatus including: an image forming unit configured to form an image with print content indicated by a print job; a memory configured to store print jobs to be executed by the image forming unit and execution sequences for the print jobs; a control unit configured to cause the image forming unit to execute the print jobs according to the execution sequences stored by the memory; a measuring unit configured to measure execution time of a print job that the control unit causes the image forming unit to execute; a job switching unit configured to suspend the print job if the execution time of the print job measured by the measuring unit exceeds designated execution time and cause the image forming unit to execute a print job of the next execution sequence stored by the memory.

According to another aspect of the present invention, there is provided a print control method including: storing, in a memory, print jobs that an image forming apparatus should execute and execution sequences for the print jobs; causing the image forming apparatus to execute the print jobs according to the execution sequences stored in the memory; measuring, with a timer, execution time of a print job that the image forming apparatus is caused to execute; suspending the print job if the execution time of the print job measured by the timer exceeds designated execution time and causing the image forming apparatus to execute a print job next in the execution sequences stored in the memory.

According to still another aspect of the present invention, there is provided an image forming apparatus including: image forming means for forming an image with print content indicated by a print job; storing means for storing print jobs to be executed by the image forming means and execution sequences for the print jobs; control means for causing the image forming means to execute the print jobs according to the execution sequences stored by the storing means; measuring means for measuring execution time of a print job that the control means causes the image forming means to execute; job switching means for suspending the print job if the execution time of the print job measured by the measuring means exceeds designated execution time and causing the image forming means to execute a print job next in the execution sequences stored by the storing means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specifications, illustrate embodiments of the invention, and together with the general description given above and the detailed description of the embodiments given below, serve to explain the principles of the invention.

FIG. 1 is a schematic diagram of a configuration example of an image forming system;

FIG. 2 is a block diagram of a configuration example of a control system for a digital multi function peripheral and a user terminal;

FIG. 3 is a diagram of a configuration example of a table for managing jobs;

FIG. 4 is a diagram of a display example of a list of a job queue;

FIG. 5 is a diagram of a display example of the list of a job queue;

FIG. 6 is a diagram of a display example of a setting screen concerning job control;

FIG. 7 is a diagram of a display example of remaining time until a job being executed is switched to the next job and a forced extension key;

FIG. 8 is a flowchart for explaining a flow of job control; and

FIG. 9 is a flowchart for explaining a flow of forced extension processing.

### DETAILED DESCRIPTION

An embodiment of the present invention is explained below with reference to the accompanying drawings.

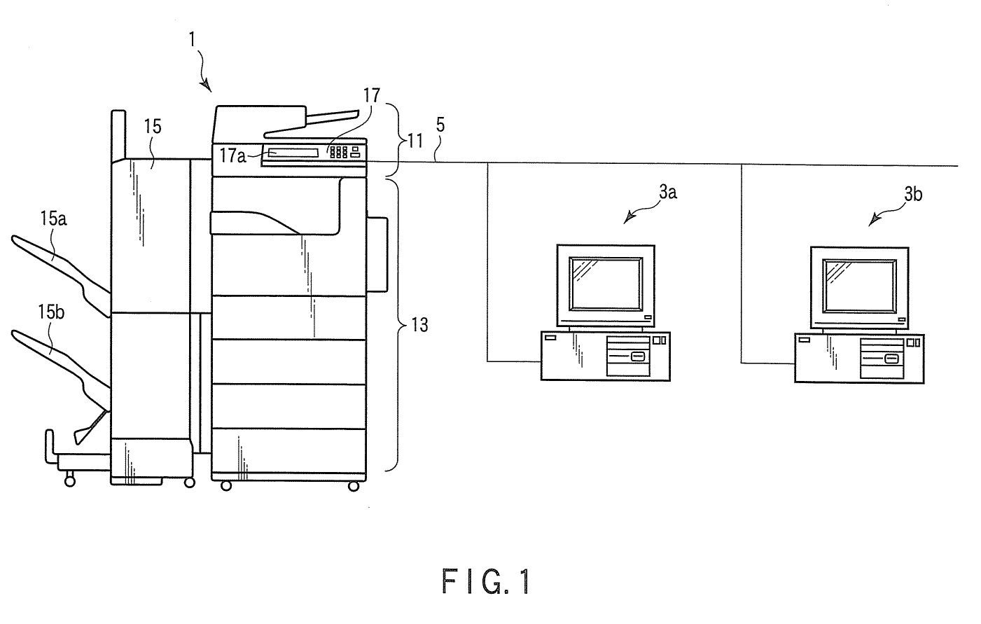

FIG. 1 is a diagram of a schematic configuration of an image forming system including a digital multi function peripheral that has functions of an image forming apparatus and a printing control apparatus.

As shown in FIG. 1, the image forming system includes a digital multi function peripheral 1, plural user terminals 3 (3a, 3b, etc.), and a local area network 5.

The digital multi function peripheral (NFP) 1 functions as an image forming apparatus. The digital multi function peripheral 1 has a scanner function, a printer function, a network communication function, and the like. Each of the user terminals 3 (3a, 3b, etc.) includes a personal computer. The user terminal 3 is a terminal apparatus used by a user. The user terminal 3 performs data communication with the digital multi function peripheral 1 via the local area network 5. For example, the user terminal 3 requests, via the local area network 5, the digital multi function peripheral 1 to perform printing.

The digital multi function peripheral 1 includes a scanner (an image reading unit) 11, a printer (an image forming unit) 13, a finisher 15, and an operation panel 17. The digital multi function peripheral 1 further includes various external interfaces for inputting and outputting image data. For example, the digital multi function peripheral 1 includes a facsimile interface for transmitting and receiving facsimile data and a network interface for performing network communication. With such a configuration, the digital multi function peripheral 1 functions as a copying machine, a scanner, a printer, a facsimile, and a network communication apparatus.

The scanner 11 is a unit configured to read an image on a document surface as color image data (multi-value image data) or monochrome image data. The scanner 11 reads the image on the document surface by optically scanning the document surface. The scanner 11 includes a scanning mechanism, a photoelectric conversion unit, and an auto document feeder (ADF).

The printer 13 is a unit configured to form an image based on the color image data (the multi-value image data) or the monochrome image data on a sheet. For example, the printer 13 is an image forming apparatus of an electrophotographic system including a sheet storing unit, a conveying mechanism, an exposing device, photoconductive drums, developing devices, a transfer belt, a transfer device, and a fixing device. The printer 13 is not limited to the electrophotographic system. A printing system such as an ink jet system or a thermal transfer system may be adopted.

In the printer 13, the conveying mechanism conveys a sheet set in the sheet storing unit. The exposing device forms latent images on the photoconductive drums. The developing devices develop the latent images on the photoconductive drums with a toner (in the case of color printing, toners of respective colors). The transfer device transfers toner images on the photoconductive drums developed by the developing devices onto the sheet via the transfer belt. The fixing device fixes the toner images on the sheet by heating the sheet in a pressed state. The conveying mechanism outputs the sheet having the toner images fixed thereon to the finisher 15 as a printing result.

The printer 13 also includes a sensor (not shown) configured to detect various states. For example, the printer 13 includes a sensor configured to detect residual amounts of the toners, a sensor configured to detect presence or absence of sheets in the sheet storing unit, and a sensor configured to detect a conveying state (e.g., a jam) of a sheet by the conveying mechanism. The sensors provided in the printer 13 notify a system control unit 20 explained later of detection signals.

The finisher 15 includes a conveying mechanism and plural paper discharge trays 15a and 15b. The conveying mechanism selectively conveys a sheet as a printing result supplied from the printer 13 to the paper discharge tray 15a or 15b. The finisher 15 may include a stapler for stapling sheets or a hole punch unit.

The operation panel 17 is a user interface. The operation panel 17 includes various operation keys and a display unit 17a incorporating a touch panel. The operation panel 17 functions as an operation unit for a user to input an operation instruction and a display unit configured to display guidance and the like for the user.

The configuration of a control system for the digital multi function peripheral 1 is explained below.

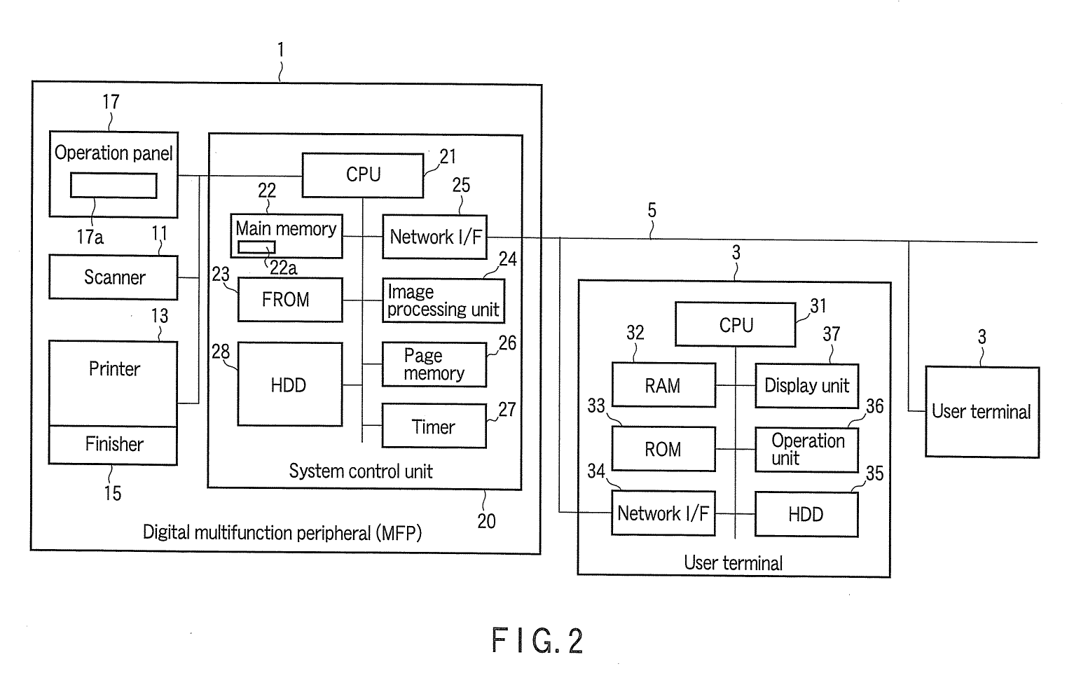

FIG. 2 is a block diagram of a configuration example of the control system for the digital multi function peripheral 1.

As shown in FIG. 2, the digital multi function peripheral 1 includes a system control unit 20 configured to collectively control the units of the digital multi function peripheral 1. For example, the system control unit 20 controls the scanner 11 and the printer 13. The system control unit 20 acquires an instruction of a user from the operation panel 17. The system control unit 20 includes a CPU 21, a main memory 22, an FROM 23, an image processing unit 24, a network interface 25, a page memory 26, a timer 27, and a HDD 28.

The CPU 21 is a processor configured to perform arithmetic processing. The CPU 21 realizes various processing functions by executing a control program stored in the FROM 23 or the HDD 28. The main memory 22 includes a random access memory (RAM). The main memory 22 functions as a working memory. The main memory 22 stores flags indicating operation states of the units. The main memory 22 has a table 22a for managing print processing as a job. The table 22a stores management information for controlling jobs such as the print processing. For example, the table 22a stores management information indicating printing order of the jobs.

The FROM 23 includes a rewritable nonvolatile memory. The FROM 23 has stored therein a control program, control data, and the like for managing the operation of the digital multi function peripheral 1. The control data, setting information, or the like is written in the FROM 23. Various flags indicating various operation states may be stored in the FROM 23. The image processing unit 24 applies image processing to image data read by the scanner 11 or image data received from the user terminal 3 via a network. For example, the image processing unit 24 has a RIP function for generating image data by rasterizing a page description language received from the user terminal 3 via the local area network 5. The CPU 21 may realize the RIP function by executing a computer program stored in the FROM 23 using the main memory 22.

The network interface 25 is a LAN interface for performing communication with an external apparatus via the local area network 5. The page memory 26 is a memory for expanding image data for printing. In the page memory 26, an area for expanding image data equivalent to at least one page can be secured. The timer 27 counts elapsed time. The HDD 28 is a large-capacity memory for data storage. The HDD 28 accumulates, for example, print target image data.

The configuration of the user terminal 3 is explained below.

The user terminal 3 has a configuration same as that of a general personal computer. For example, in the configuration example shown in FIG. 2, the user terminal 3 includes a CPU 31, a RAM 32, a ROM 33, a network interface (I/F) 34, a HDD 35, an operation unit 36, and a display unit 37.

The CPU 31 manages the control of the entire user terminal 3. The CPU 31 realizes various processing functions on the basis of a control program stored in the ROM 33 and the HDD 35. The RAM 32 is a working memory. The ROM 33 has stored herein the control program, control data, and the like for managing the basic operation of the user terminal 3. The HDD 35 is a storage device for data storage. The operation unit 36 is a keyboard, a pointing device, and the like for the user to input an operation instruction. The display unit 37 includes a liquid crystal display. The network interface 34 is a LAN interface for performing data communication with apparatuses in the local area network 5. For example, the user terminal 3 can transmit data to and receive data from the digital multi function peripheral 1 through the network interface 34 via the local area network 5.

Management of jobs in the digital multi function peripheral 1 is explained below.

The system control unit 20 of the digital multi function peripheral 1 manages print processing for a read image of an original document and print processing for image data received via the network 5 as jobs, respectively. Plural kinds of print processing (jobs) cannot be simultaneously executed. Therefore, when there are plural kinds of print processing that cannot be simultaneously executed, the system control unit 20 of the digital multi function peripheral 1 manages those kinds of print processing as jobs, respectively, and controls execution sequences of the jobs.

For example, in copy processing, the system control unit 20 stores images of original documents of one page or plural pages, which are read by the scanner 11, as document image data (document image data including image data of one or plural pages) for printing in the HDD 28. The system control unit 20 manages, as one job, print processing for printing one copy or plural copies of the document image data stored in the HDD 28.

Specifically, in the digital multi function peripheral 1, the scanner 11 reads images of original documents of one page or plural pages. The HDD 28 stores the image data of one or plural pages, which is read by the scanner 11, as document image data for printing. The table 22a of the system control unit 20 stores print processing of the document image data, which is stored in the HDD 28, as jobs in association with one another in execution order. The CPU 21 of the system control unit 20 executes the respective kinds of print processing, which are managed as the jobs, in the execution order stored in the table 22a.

In network print processing, the system control unit 20 stores document image data for printing (document image data including image data of one page or plural pages) received from the user terminal 3 together with a print request in the HDD 28. The system control unit 20 manages print processing for the document image data, which is stored in the HDD 28, as jobs. For example, the user terminal 3 converts image data of one or plural pages that should be printed into a page description language and transmits the page description language to the digital multi function peripheral 1 through the network interface 34.

In the digital multi function peripheral 1, the page description language received by the network interface 25 is rasterized by the RIP function of the image processing unit 24. The HDD 28 stores the rasterized document image data for printing (the image data of one or plural pages). The table 22a stores print processing for printing one or plural copies of the document image data, which is stored in the HDD 28, as jobs in association with one another in execution order. The CPU 21 of the system control unit 20 executes the respective kinds of print processing, which are managed as the jobs, in the execution order stored in the table 22a.

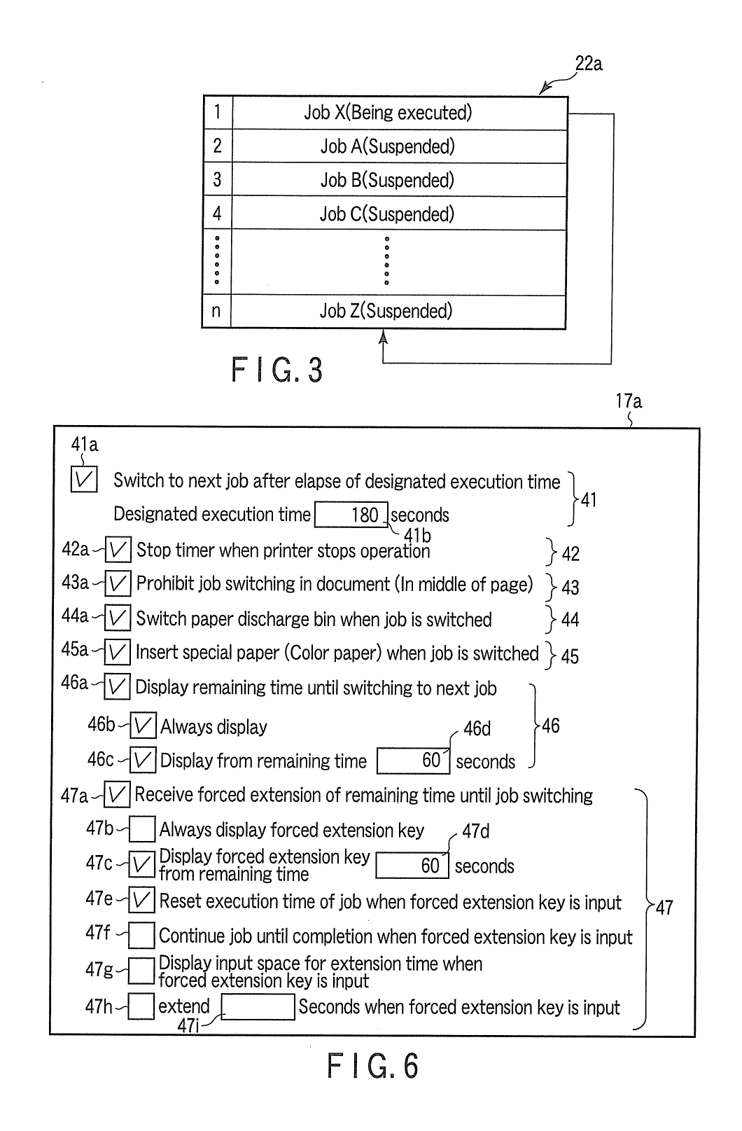

FIG. 3 is a diagram of an example of the table 22a for managing jobs.

As shown in FIG. 3, plural jobs and execution sequences of the jobs are registered in the table 22a. For example, the CPU 21 of the system control unit 20 gives execution sequences to the jobs, which are registered in the table 22a, in order from the job registered at the earliest timing. As an example of the registration of the jobs, in the copy processing, at a stage when the scanner 11 starts reading of an original document or at a stage when the scanner 11 ends reading of all original documents, the CPU 21 of the system control unit 20 registers the copy processing (or print processing in the copy processing) in the table 22a as a job. In the network print processing, at a stage when print data for one page is received, at a stage when all print data are received, or at a stage when reception of print data is started, the CPU 21 of the system control unit 20 registers the print processing in the table 22a as a job.

The CPU 21 of the system control unit 20 has a queuing function for managing plural jobs using the table 22a. The queuing function is realized by the CPU 21 executing a computer program stored in the FROM 23 using the main memory 22. The CPU 21 sequentially executes the jobs according to the execution sequences stored in the table 22a. In the example shown in FIG. 3, the table 22a arranges and stores the jobs, which are put in a queue, in execution sequences with a job X being executed arranged at the top. When the jobs are arranged and managed in the execution sequences in the table 22a, the CPU 21 executes the jobs in the order of arrangement in the table 22a.

In the job management performed by using the table 22a shown in FIG. 3, the CPU 21 can register a suspended job in the table 22a again as a job put in a queue. When a job being executed is suspended, the CPU 21 executes a job of the next execution sequence (the next job) among the jobs put in a queue. For example, when the job X being executed is suspended, the CPU 21 moves the suspended job X to the last of all the jobs put in a queue in the table 22a such that the suspended job X is placed in the last in the execution sequences.

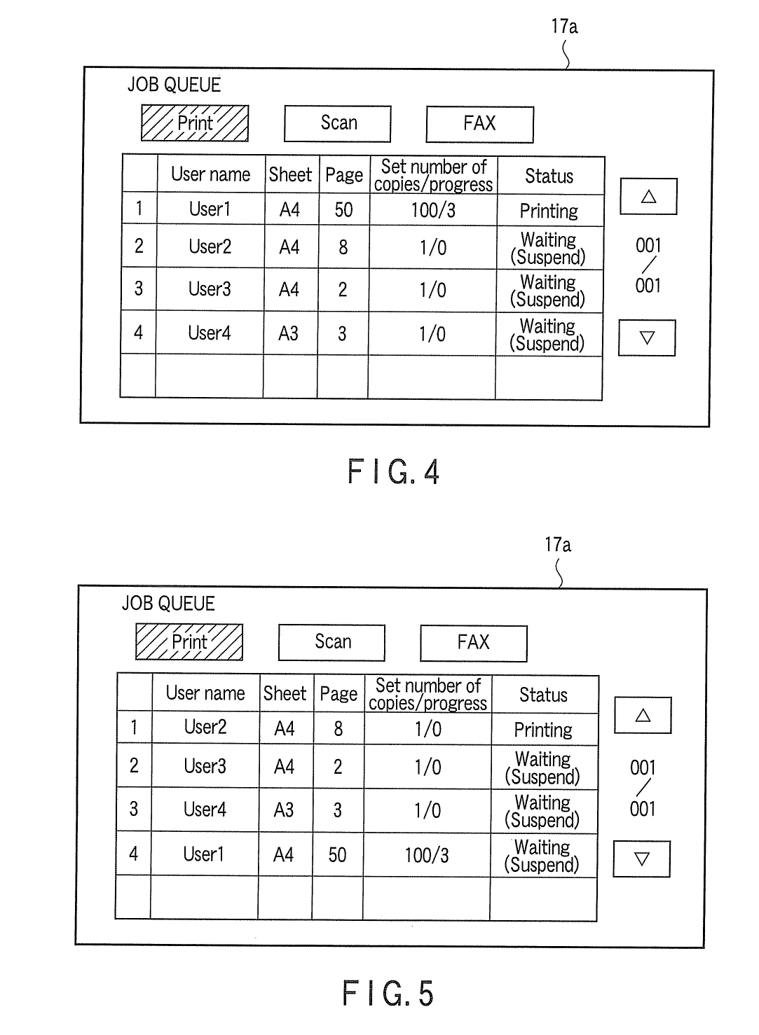

The digital multi function peripheral 1 also has a function of displaying a list of a job queue on the display unit 17a of the operation panel 17. FIGS. 4 and 5 are diagrams of examples of the display on the display unit 17a of the list of the job queue.

In the examples of the list of the job queue shown in FIGS. 4 and 5, the display unit 17a arranges and displays, in execution sequences, a job being executed and jobs queued for execution. In the display examples shown in FIGS. 4 and 5, for each of the jobs, a user name, a sheet, the number of pages, a set number of copies, a progress state, and a status are shown. In the job queue list shown in FIGS. 4 and 5, the jobs are arranged and displayed from the top according to the execution sequences. For example, in the example shown in FIG. 4, the execution sequences of the jobs are in the order of a job of a user 1, a job of a user 2, a job of a user 3, and a job of a user 4. In the example shown in FIG. 5, the execution sequences of the jobs are in the order of the job of the user 2, the job of the user 3, the job of the user 4, and the job of the user 1.

In the example shown in FIG. 4, the job being executed (printing) is the job of the user 1. The job of the user 1 is a job for printing one hundred copes of a document including fifty pages. In the progress state shown in FIG. 4, the job of the user 1 being executed is at a stage when printing of three copies is completed.

In job control explained later, when execution time or the like of a job satisfies a set condition, a job being executed is suspended and the next job is executed (i.e., a job is switched). In switching control of a job, a job being executed is suspended and the next job is executed. The suspended job is re-registered (registered in the last of a job groups queued for execution).

When a condition for switching a job is satisfied during the execution of the job of the user 1 shown in FIG. 4 (e.g., when execution time of the job of the user 1 exceeds a time limit), the job of the user 1 being executed is suspended and the job of the user 2 is started to be executed as the next job. In this case, the job of the user 1 to be re-registered is given the last execution sequence and registered in the last of the job queue. The suspended job of the user 1 is re-registered together with information indicating printing content executed until the job is suspended.

For example, when execution time of the job of the user 1 shown in FIG. 4 exceeds a time limit at a point when printing of a forty-first copy is completed, the job of the user 1 being executed is suspended and the job of the user 2 is executed as the next job. In this case, since the suspended job of the user 1 is re-registered, the job queue changes to a state indicated by the display example shown in FIG. 5. In the display example shown in FIG. 5, the job of the user 1 is changed to a job having the last execution sequence (a suspended job) and the job of the user 2 is changed to a job being executed. The execution sequences of the job of the user 3 and the job of the user 4 are carried up by one as shown in FIG. 5. In the display example shown in FIG. 5, the re-registered job of the user 1 is suspended at a point when printing of forty-one copies among one hundred copies to be printed is completed.

Control of jobs is explained below.

The digital multi function peripheral 1 has a job control function for executing, when a condition set in advance is satisfied, switching of a job, i.e., suspending a job being executed and executing the next job. The job control function is realized by the CPU 21 of the system control unit 20 executing a computer program stored in the FROM 23.

In the digital multi function peripheral 1, it is possible to set designated execution time (a time limit) for one job as a condition for automatically switching a job being executed to the next job. In the digital multi function peripheral 1, it is also possible to set various additional conditions concerning switching control for a job in addition to the setting for the designated execution time (the limit time) for one job. For example, as the setting concerning the switching control for a job, it is conceivable to stop counting the time limit when the operation of the printer 13 is stopped (absence of toner, absence of sheets, or a conveyance jam), prohibit switching of a job in the middle of a page, switch a paper discharge bin during job switching, insert special paper (e.g., color paper) during job switching, display remaining time until switching to the next job, or allow reception of an extension instruction for the time limit for a job being executed.

FIG. 6 is a diagram of a display example of a setting screen concerning the switching control for a job.

The setting screen concerning the switching control for a job of FIG. 6 is displayed on, for example, the display unit 17a of the operation panel 17. In the setting screen shown in FIG. 6, various setting items related to the switching control for a job are displayed side by side.

For example, in the example of the setting screen shown in FIG. 6, it is possible to set whether switching of a job according to the time limit should be performed. A setting item concerning the switching of a job is displayed in a display area 41. When the switching of a job according to the time limit is performed, an administrator or a user sets, in the setting screen shown in FIG. 6, a check mark in a checkbox 41a of the display area 41 including a guidance indication “switch to the next job after elapse of the fixed time”. When the check mark is set in the checkbox 41a, the switching of a job according to the time limit is activated. When the check mark is set in the checkbox 41a, the CPU 21 of the system control unit 20 stores, in the FROM 23 or the HDD 28, setting information indicating that the switching of a job according to the time limit is activated.

Further, an input space 41b for the time limit with respect to execution time for one job is also displayed in the display area 41 in the setting screen shown in FIG. 6. In the example of the setting screen shown in FIG. 6, the administrator or the user inputs time as the time limit to the input space 41b in second units. When the time is input to the input space 41b, the time limit with respect to the execution time for the job is set to the time input to the input space 41b. The CPU 21 stores the time input to the input space 41b in the FROM 23 or the HDD 28 as a set value for the time limit with respect to the execution time for the job. The time limit may be a predetermined fixed value.

Further, in the setting screen shown in FIG. 6, it is possible to set conditions for job control besides the time limit with respect to the execution time for one job.

For example, job control performed when the printer 13 stops operation can be set. It is possible to set to stop counting the execution time of a job being executed during the stop of the operation of the printer 13 due to absence of toner, absence of sheets, a jam, or the like. When the counting of execution time for a job is stopped during the stop of the operation of the printer 13, it is possible to control job switching with substantial execution time for the job. A setting item concerning the job control performed when the printer 13 stops operation is displayed in a display area 42.

When the counting of the execution time of the job is stopped during the stop of the operation of the printer 13, the administrator or the user sets a check mark in a checkbox 42a of the display area 42 including a guidance indication “stop the timer when the printer stops operation” in the setting screen shown in FIG. 6. When the check mark is set in the checkbox 42a in the setting screen shown in FIG. 6, setting for stopping the counting of the execution time for the job during the stop of the operation of the printer 13 is activated. When the check mark is set in the checkbox 42a, the CPU 21 of the system control unit 20 stores, in the FROM 23 or the HDD 28, setting information indicating that the counting of the execution time for the job is stopped when the printer 13 stops operation.

Information indicating an operation state corresponding to the setting information may be stored in the FROM 23 as a flag. For example, while the counting of the execution time is stopped according to the stop of the operation of the printer 13, the CPU 21 may set a timer stop flag in the FROM 23. With the timer stop flag, the CPU 21 can easily identify that the counting of the execution time is stopped according to the stop of the operation of the printer 13.

As the setting for the job control, it is possible to set suspension of a job for switching the job as the time of completion of printing in copy units. If a job being executed is suspended in copy units and switched to the next job (i.e., job switching is prohibited in the middle of a page), a print result is obtained in copy (document) units and the jot is not suspended in the middle of the page. This means that the print result of the suspended job is a print result of at least one or more copies. A setting item concerning the suspension of a job in copy units is displayed in a display area 43.

When a job is suspended in copy (document) units (i.e., job switching is prohibited in the middle of a page), the administrator or the user sets, in the setting screen shown in FIG. 6, a check mark in a checkbox 43a of the display area 43 including a guidance indication “prohibit job switching in the document (in the middle of the page)”. When the check mark is set in the checkbox 43a, switching of a job in a document (in the middle of a page) is prohibited. When the check mark is set in the checkbox 43a, the CPU 21 of the system control unit 20 stores, in the FROM 23 or the HDD 28, setting information indicating that switching of a job in a document (in the middle of a page) is prohibited.

While job switching is prohibited because printing is in a document (in the middle of a page), the CPU 21 may set, in the FROM 23, an intra-document switching prohibition flag indicating that switching of a job is prohibited because printing is in a document. With the intra-document switching prohibition flag, the CPU 21 can easily identify that job switching is prohibited because printing is in a document (in the middle of a page).

Further, as the setting for the job control, it is possible to set the operation of the printer 13 during job switching. As the setting for the operation of the printer 13 during the job switching, there is switching of a paper discharge bin, insertion of special paper, or the like. For example, if a paper discharge bin is switched according to switching of a job, it is easy to sort a print result of a suspended job and a print result of the next job. If special paper is inserted (automatic paper discharge) during the job switching, it is easy to sort a print result of a suspended job and a print result of the next job.

In the setting screen shown in FIG. 6, a setting item concerning switching of a paper discharge bin during switching of a job is displayed in a display area 44. When it is set to also switch a paper discharge bin according to switching of a job, the administrator or the user sets a check mark in the checkbox 44a of the display area 44 including a guidance indication “switch the paper discharge bin during job switching” in the setting screen shown in FIG. 6. When the check mark is set in the checkbox 44a, switching of a paper discharge bin during job switching is activated. When the check mark is set in the checkbox 44a, the CPU 21 of the system control unit 20 stores, in the FROM 23 or the HDD 28, setting information indicating that a paper discharge bin is switched during job switching.

In the setting screen shown in FIG. 6, a setting item concerning insertion of special paper during switching of a job is displayed in a display area 45. When it is set to insert special paper according to switching of a job, the administrator or the user sets a check mark in a checkbox 45a of the display area 45 including a guidance indication “insert the special paper (color paper) during job switching” in the setting screen shown in FIG. 6. When the check mark is set in the checkbox 45a, insertion of special paper during job setting is activated. When the check mark is set in the checkbox 45a, the CPU 21 of the system control unit 20 stores, in the FROM 23 or the HDD 28, setting information indicating that special paper is inserted during job switching. The special paper is a sheet stored in any one of sheet storing units in the digital multi function peripheral 1. Therefore, as the special paper, the sheet storing unit only has to be set.

As the setting for the job control, it is possible to set to display remaining time until switching to the next job. In the setting screen shown in FIG. 6, a setting item concerning display of remaining time until switching to the next job is displayed in a display area 46. The remaining time until switching to the next job is displayed on the display unit 17a of the operation panel 17 according to the control by the CPU 21. The CPU 21 can display the remaining time on the display unit 17a by performing interrupt processing at a fixed interval. For example, the remaining time may be calculated by subtracting a count value of execution time for a job being executed from the designate execution time (the time limit).

If the job being executed ends within the time limit, it is considered to be less necessary to display remaining time until the job being executed is switched to the next job. Therefore, if the job being executed ends within the time limit, remaining time for the job being executed does not have to be displayed.

When the remaining time until switching to the next job is displayed, the administrator or the user sets a check mark in a checkbox 46a of the display area 46 including a guidance indication “display the remaining time until switching to the next job” in the setting screen shown in FIG. 6. When the check mark is set in the checkbox 46a, the display of the remaining time until switching to the next job is activated. For example, when the check mark is set in the checkbox 46a, the CPU 21 of the system control unit 20 stores, in the FROM 23 or the HDD 28, setting information indicating that the remaining time until switching to the next job is displayed.

In the display area 46 in the setting screen shown in FIG. 6, timing for displaying the remaining time until switching to the next job can also be set. In the display example shown in FIG. 6, as the timing for displaying the remaining time, it is possible to set to always display the remaining time or display the remaining time at timing when the remaining time decreases to be shorter than set time.

For example, when the remaining time is always displayed, the administrator or the user sets a check mark in a checkbox 46b corresponding to guidance “always display” in the setting screen shown in FIG. 6. When the check mark is set in the checkbox 46b, remaining time of a job being executed is always displayed on the display unit 17a. When the check mark is set in the checkbox 46b, the CPU 21 of the system control unit 20 stores, in the FROM 23 or the HDD 28, setting information indicating that the remaining time is always displayed.

When the remaining time is displayed at timing when the remaining time decreases to be shorter than the set time, the administrator or the user sets a check mark in a checkbox 46c corresponding to guidance “display from remaining time seconds” in the setting screen shown in FIG. 6 and inputs set time to an input space 46d. When the check mark is set in the checkbox 46c and the set time is input to the input space 46d, the remaining time is displayed at timing when the remaining time of the job being executed decreases to be shorter than the set time input to the input space 46d. When the check mark is set in the checkbox 46c, the CPU 21 of the system control unit 20 stores, in the FROM 23 or the HDD 28, time input to the input space 46d as set time for displaying the remaining time.

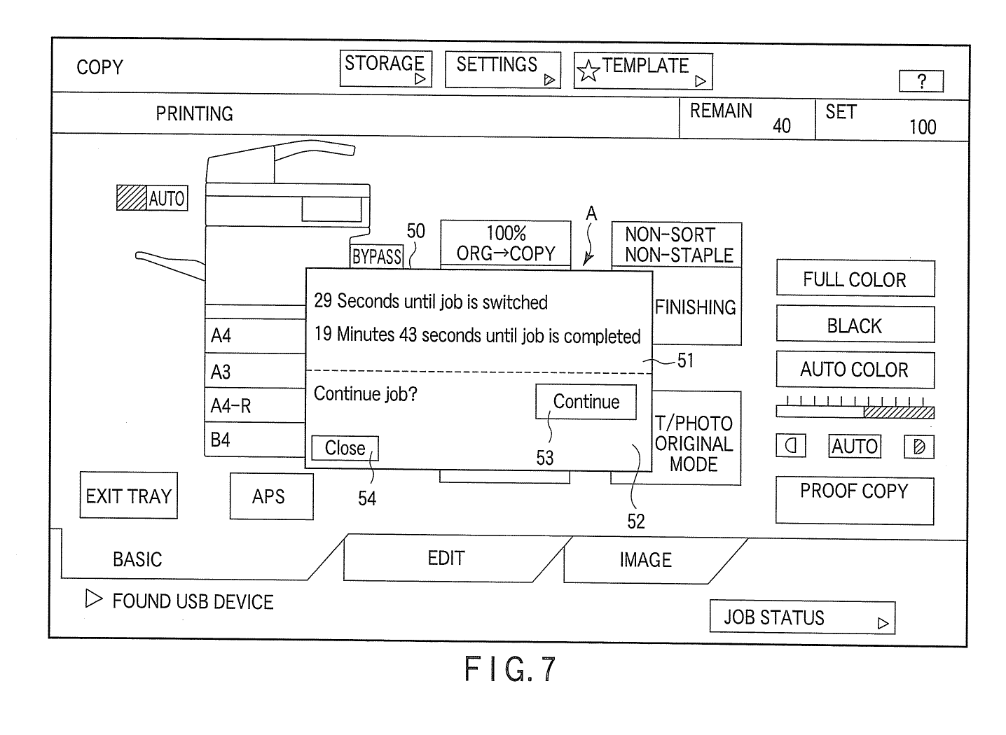

As the setting for the job control, setting for receiving an extension instruction remaining time until switching to the next job (a continuation instruction for a job being executed) is possible. A setting item concerning extension of the remaining time until switching to the next job is displayed in a display area 47. The extension of the remaining time until switching to the next job (continuation of the job being executed) is executed according to an input to a forced extension key (see FIG. 7 referred to later) provided in the operation panel 17. In this embodiment, the forced extension key is displayed on the display unit 17a of the operation panel 17 as an icon selectable on a touch panel. For example, the forced extension key may be displayed together with the remaining time of the job being executed.

When an instruction of forced extension for the remaining time is allowed, the user present in front of the digital multi function peripheral 1 (a place where the user can directly operate the operation panel 17) can continue the job being executed exceeding the time limit without switching the job being executed.

If the job being executed ends within the time limit, it is considered unnecessary to extend the remaining time. Therefore, if the job being executed ends within the time limit, control for receiving an extension instruction for the remaining time does not have to be performed. In other words, in this embodiment, the forced extension key does not have to be displayed if the job being executed ends within the time limit.

When the extension instruction for the remaining time is allowed to be received, the administrator or the user sets a check mark in a checkbox 47a of the display area 47 including a guidance indication “receive forced extension of the remaining time until job switching” in the setting screen shown in FIG. 6. When the check mark is set in the checkbox 47a, an instruction for forcibly extending the remaining time until switching to the next job (an input to the forced extension key) is activated. When the check mark is set in the checkbox 46a, the CPU 21 of the system control unit 20 stores, in the FROM 23 or the HDD 28, setting information indicating that forced extension of the remaining time until switching to the next job is received.

In the display area 47 in the setting screen shown in FIG. 6, timing for allowing reception of the forced extension of the remaining time until switching to the next job can also be set. In the display example shown in FIG. 6, as the timing for allowing reception of the forced extension, timing for displaying the forced extension key for instructing the forced extension can be set.

For example, when the forced extension key is always displayed, the administrator or the user sets a check mark in the checkbox 47b corresponding to guidance “always display the forced extension key” in the setting screen shown in FIG. 6. When the check mark is set in the checkbox 47b, the forced extension key is always displayed on the display unit 17a. When the check mark is set in the checkbox 47b, the CPU 21 of the system control unit 20 stores, in the FROM 23 or the HDD 28, setting information indicating that the forced extension key is always displayed.

When the forced extension key is displayed at the timing when the remaining time decreases to be shorter than the set time, the administrator or the user sets a check mark in a checkbox 47c corresponding to guidance “display the forced extension key from remaining time seconds” in the setting screen shown in FIG. 6 and inputs set time in an input space 47d. When the check mark is set in the checkbox 47c and the set time is input to the input space 47d, the forced extension key is displayed at timing when the remaining time of the job being executed decreases to be shorter than the set time input to the input space 47d. When the check mark is set in the checkbox 47c, the CPU 21 of the system control unit 20 stores, in the FROM 23 or the HDD 28, time input to the input space 47d as set time for displaying the forced extension key.

The checkbox 47b and the checkbox 47c cannot be simultaneously selected. Only one of the checkbox 47b and the checkbox 47c is selected. The same time may be input to the input space 47d and the input space 46d. For example, in an operation form for displaying the forced extension key together with remaining time, the same time may be input to the input space 47d and the input space 46d.

In the display area 47 in the setting screen shown in FIG. 6, it is possible to set extension time corresponding to the input of remaining time to the forced extension key. In the display example shown in FIG. 6, as operation performed when the forced extension key is input, it is possible to set, for example, operation for resetting execution time of a job (extension by designate execution time), operation for extending the execution time until completion of the job, operation for receiving designation of extension time, and operation for extending the execution time for the job by set time.

For example, when the execution time of the job is reset according to the input of the forced extension key, the administrator or the user sets a check mark in a checkbox 47e corresponding to guidance “reset execution time of the job when the forced extension key is input” in the setting screen shown in FIG. 6. When the check mark is set in the checkbox 47e, execution time of a job being executed is reset according to the input of the forced extension key (remaining time is extended by designated execution time). When the check mark is set in the checkbox 47e, the CPU 21 of the system control unit 20 stores, in the FROM 23 or the HDD 28, setting information indicating that the execution of the job is reset according to the input of the forced extension key.

When the job being executed is continued to completion according to the input of the forced extension key (i.e., switching of the job being executed to the next job is prohibited), the administrator or the user sets a check mark in a checkbox 47f corresponding to guidance “extend to completion of the job when the forced extension key is input” in the setting screen shown in FIG. 6. When the checkmark is set in the checkbox 47f, the job being executed is continued until completion according to the input of the forced extension key. When the check mark is set in the checkbox 47f, the CPU 21 of the system control unit 20 stores, in the FROM 23 or the HDD 28, setting information indicating that the job being executed is continued until completion according to the input of the forced extension key.

When the input of extension time for remaining time is received according to the input of the forced extension key, the administrator or the user sets a check mark in a checkbox 47g corresponding to guidance “display the input space for extension time when the forced extension key is input” in the setting screen shown in FIG. 6. When the check mark is set in the checkbox 47g, an input space to which extension time for the remaining time of the job being executed is input is displayed according to the input of the forced extension key. When the check mark is set in the checkbox 47g, the CPU 21 of the system control unit 20 stores, in the FROM 23 or the HDD 28, setting information indicating that the input of the extension time for the remaining time of the job being executed is received according to the input of the forced extension key.

When the remaining time is extended by extension time set in advance according to the input of the forced extension key, the administrator or the user sets a check mark in a checkbox 47h corresponding to guidance “extend seconds when the forced extension key is input” in the setting screen shown in FIG. 6 and inputs the extension time to an input space 47i. When the check mark is set in the checkbox 47h and a set value of the extension time is input to the input space 47i, the remaining time of the job being executed is extended by the extension time input to the input space 47i according to the input of the forced extension key. When the check mark is set in the checkbox 47h, the CPU 21 of the system control unit 20 stores, in the FROM 23 or the HDD 28, time input to the input space 47i as extension time (predefined extension time) for extending the remaining time of the job being executed according to the input of the forced extension key.

Plural ones of the checkboxes 47e to 47h cannot be simultaneously selected. Any one of the checkboxes 47e to 47h is selected.

FIG. 7 is a display example of the remaining time until the job being executed is switched to the next job and the forced extension key.

In the example shown in FIG. 7, the remaining time and the forced extension key are displayed on the display unit 17a. In the example shown in FIG. 7, a guide screen (a window screen) including the remaining time and the forced extension key is displayed in a display area 50 on the setting screen displayed on the display unit 17a. The guide screen displayed in the display area 50 includes a display area 51 for displaying the remaining time and a display area 52 for displaying a forced extension key 53.

In the display area 51 for the remaining time, time until a job is switched (time until the job being executed is suspended) and time until the job being executed is completed (predicted time) are displayed. In the display area 51 for the remaining time, the remaining time is displayed according to content set in the setting screen shown in FIG. 6. For example, when it is set to always display the remaining time, the remaining time is always displayed in the display area 51. When it is set to display the remaining time when the remaining time is shorter than set time, the remaining time is displayed in the display area 51 at timing when the remaining time decreases to be shorter than the set time.

In the display area 52 of the forced extension key, an icon (the forced extension key) 53 indicated as “continue” is displayed together with guidance “continue the job?”. Further, in the display area 52, a “close key” 54 for instructing closure of the entire guide screen which is the display area 50 is also displayed. In the display area 52 of the forced extension key, the forced extension key 53 is displayed according to content set in the setting screen shown in FIG. 6. For example, when it is set to always display the forced extension key 53, the forced extension key 53 is always displayed in the display area 52. When it is set to display the forced extension key 53 when the remaining time is shorter than the set time, the forced extension key 53 is displayed in the display area 52 at timing when the remaining time decreases to be shorter than the set time.

As explained above, if the job being executed ends within the time limit, the guide screen shown in FIG. 7 does not have to be displayed in the display area 50.

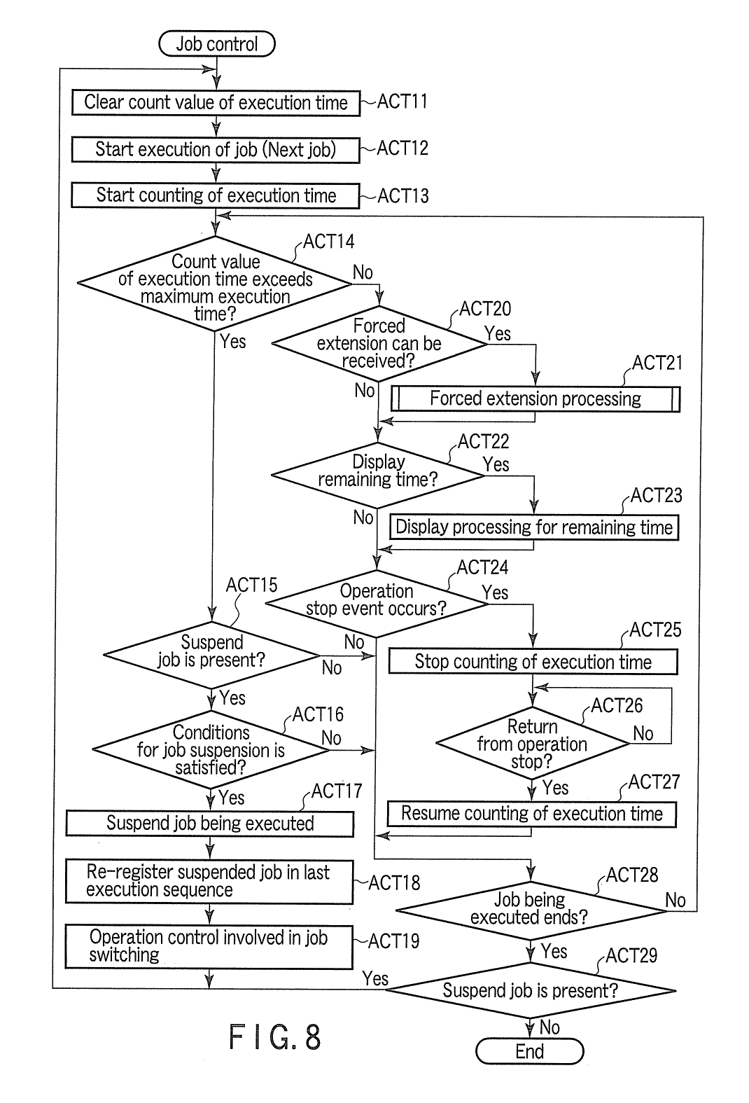

FIG. 8 is a flowchart for explaining a flow of the switching control for a job.

The digital multi function peripheral 1 controls, with the CPU 21 of the system control unit 20, execution of the jobs registered in the table 22a. When a job queued for execution registered in the table 22a is changed to a print execution state (i.e., the job is started), the CPU 21 clears a count value of execution time counted by the timer 27 (ACT 11) and starts execution of the job (ACT 12). The count value of the execution time is stored in, for example, a counter area secured on the main memory 22. Simultaneously with the start of the execution of the job, the CPU 21 starts, with the timer 27, counting of the execution time for the job (the job being executed) (ACT 13).

When the job is started, the CPU 21 monitors whether the count value of the execution time for the job being executed counted by the timer 27 exceeds the designated execution time (the time limit) set in advance (ACT 14). It is assumed that it is set to perform switching of the job according to the time limit. It is assumed that the time limit as the designated execution time is set in, for example, the setting screen shown in FIG. 4.

If the count value of the execution time for the job being executed exceeds the time limit (YES in ACT 14), the CPU 21 determines whether a suspend job (a job queued for execution) is present in the table 22a (ACT 15). If it is determined that a suspend job is present (YES in ACT 15), the CPU 51 determines whether a job suspension (switching) condition is satisfied (ACT 16). For example, when switching of a job in a document (in the middle of a page) is prohibited, the CPU 51 determines whether a progress state of the job being executed is at a stage when all pages of the document are printed. If the progress state is at the stage when all the pages are printed, even if printing of all copies is not completed, the CPU 51 determines that the job suspension condition is satisfied.

If it is determined that the job suspension condition is satisfied (YES in ACT 16), the CPU 21 suspends the job being executed (ACT 17). The CPU 21 forms the remaining print job in the suspended job as a new job (a re-execution job). In the table 22a, the CPU 21 deletes the suspended job being executed and re-registers the re-execution job as a suspend job having the last execution sequence (ACT 18).

For example, when the tables 22a stores jobs in execution order as shown in FIG. 3, the CPU 21 deletes the job being executed at the top and registers the remaining print job at the tail as the re-execution job. The CPU 21 may directly re-register the suspended job as a job.

When the suspended job is re-registered in the table 22a, the CPU 21 performs printer control corresponding to operation setting involved in the switching of a job (ACT 19). For example, when it is set to switch a paper discharge bin during job switching, the CPU 21 instructs the printer 13 to switch a paper discharge bin. When it is set to insert special paper (color paper) during job switching, the CPU 21 instructs the printer 13 to insert (discharge) special paper. When such operation control involved in the switching of a job is completed, the CPU 21 returns to ACT 11, clears the count value of the execution time, and executes the next job.

If the count value of the execution time for the job being executed is within the time limit (NO in ACT 14), the CPU 21 performs various kinds of check related to the control of the job switching.

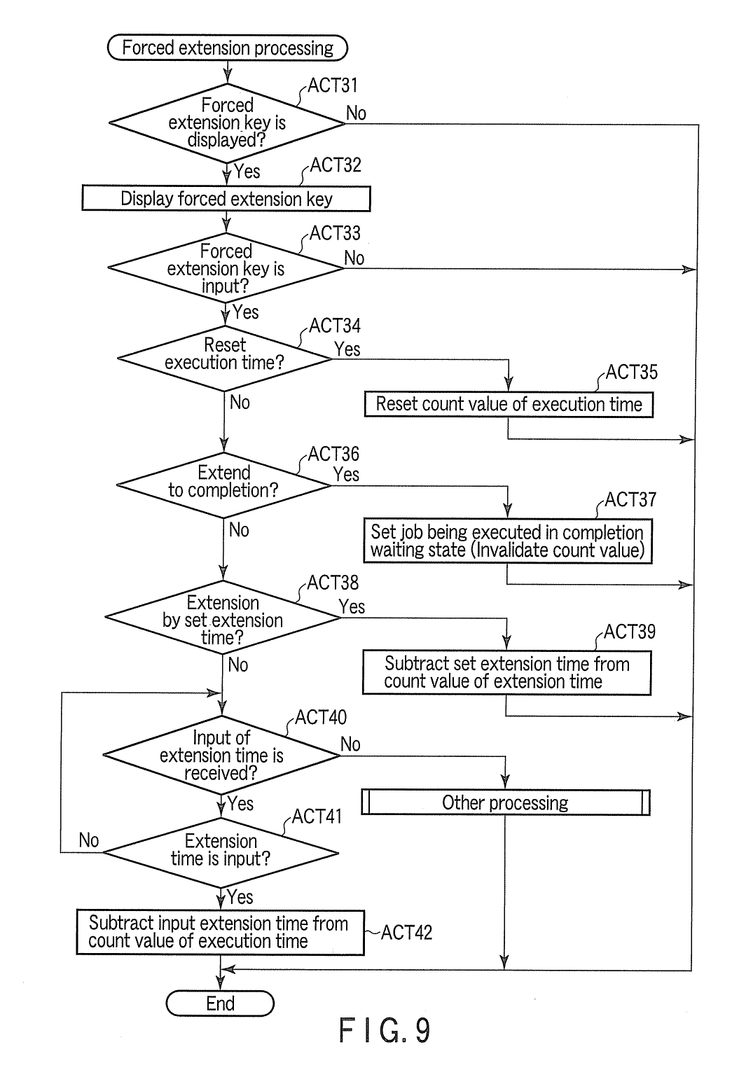

For example, if it is set to receive, according to an instruction of the user, forced extension of the remaining time with respect to the execution time of the job being executed (YES in ACT 20), the CPU 21 performs forced extension processing including display control for the forced extension key 53 (ACT 21). In the forced extension processing, the CPU 21 performs, according to the setting content set in the setting screen shown in FIG. 6, display control of the forced extension key 53 and operation (extension of the remaining time) corresponding to an input to the forced extension key 53. The forced extension processing is explained in detail later with reference to FIG. 9.

If it is set to perform the display of the remaining time (YES in ACT 22), the CPU 21 displays time obtained by subtracting the count value from the time limit on the display unit 17a of the operation panel 17 or the like as the remaining time until switching to the next time (step S23). The remaining time is displayed as, for example, a window screen shown in the display area 51 of FIG. 7. In the example shown in FIG. 7, predicted time required for completion of the job being executed is also displayed. Therefore, when the guide screen for the remaining time shown in FIG. 7 is displayed, the CPU 21 calculates time when the job being executed is completed and displays the time together with the remaining time. When set time for displaying the remaining time is set, the CPU 21 displays the remaining time on the display unit 17a at timing when the remaining time decreases to be shorter than the set time.

When it is set not to display the remaining time, the CPU 21 omits the processing in ACT 22 and ACT 23. When the job being executed is print processing corresponding to a print request from the user terminal 3, the CPU 21 may transmit the remaining time to the user terminal 3. In this case, the user terminal 3 can display the remaining time until job switching.

The counting of the execution time for the job being executed can be set to stop when the operation of the printer 13 stops. When the counting of the execution time is set to stop according to the stop of the operation of the printer 13, the CPU 21 stops the counting of the execution time according to event notification indicating the stop of the operation from the printer 13. Specifically, if event notification indicating the stop of the operation such as absence of toner, absence of sheets, or a sheet jam is received from the printer 13 (YES in ACT 24), the CPU 21 stops the counting of the execution time for the job being executed (ACT 25).

When the counting of the execution time for the job being executed also stops according to the stop of operation of the printer 13, the CPU 21 waits for notification of operation resumption from the printer 13 while keeping a count value of the stopped counting (ACT 26). If the operation of the printer 13 is resumed, i.e., when the print processing as the job being executed is resumed (YES in ACT 26), the CPU 21 resumes the counting of the execution time for the job being executed (ACT 27). When it is set not to perform stop of the count value involved in the stop of the operation of the printer 13, the CPU 21 omits the processing in ACT 24 to ACT 27.

If the count value of the execution time for the job being executed is within the time limit (NO in ACT 14), the CPU 21 monitors whether the job being executed ends while performing the various kinds of check (ACT 28). Specifically, until the job being executed ends (NO in ACT 28), the CPU 21 repeatedly executes the processing in ACT 14 and subsequent acts. If the job being executed ends (YES in ACT 28), the CPU 21 checks whether a job queued for execution (a suspend job) is present in the table 22a (ACT 29). If a suspend job is present in the table 22a (YES in ACT 29), the CPU 21 returns to ACT 11 and applies the job control explained above to the next job.

As explained above, in the digital multi function peripheral 1, the job being executed is suspended and switched to the next job when the execution time exceeds the designated execution time (the time limit) set in advance. Therefore, the printer 13 is not occupied by a job having long printing time or a job having short printing time is not unnecessarily suspended and switched. It is possible to impartially allocate resources of the printer 13 to plural jobs.

The forced extension processing as the processing in ACT 21 is explained below.

FIG. 9 is a flowchart for explaining a flow of the forced extension processing.

When it is set to receive forced extension, the CPU 21 of the system control unit 20 determines whether a condition for allowing reception of forced extension is satisfied, i.e., a condition for displaying the forced extension key (a condition for activating the forced extension key) is satisfied (ACT 31). If it is determined that the condition for displaying the forced extension key is satisfied (YES in ACT 31), the CPU 21 displays the force extension key 53 on the display unit 17a as shown in FIG. 7 (ACT 32).

For example, as the condition for displaying the forced extension key, timing for display is set. In the setting screen shown in FIG. 6, it is set whether to always display the forced extension key or display the forced extension key when the remaining time until job switching decreases to be shorter than the set time. If it is set to always display the forced extension key (YES in ACT 31), the CPU 21 immediately displays the forced extension key 53 on the display unit 17a (ACT 32). When set time for displaying the forced extension key is set, if the remaining time until job switching is shorter than the set time (YES in ACT 31), the CPU 21 displays the force extension key 53 on the display unit 17a (ACT 32).

When the forced extension key 53 is displayed, the CPU 21 monitors whether the forced extension key 53 is indicated by the user (ACT 33). If it is determined that the forced extension key 53 is indicated by the user (YES in ACT 33), the CPU 21 determines, according to set content, operation performed when the forced extension key 53 is input. For example, in the setting screen shown in FIG. 6, reset of the execution time, extension to completion, extension by set extension time, reception of the input of extension time, and the like are set in response to the input of the forced extension key.

For example, if it is set to reset, according to the input of the forced extension key, the execution time of the job being executed (YES in ACT 34), the CPU 21 resets the count value of the execution time for the job being executed (e.g., set the count value of the execution time to 0) (ACT 35).

If it is set to continue the job being executed until completion according to the input of the forced extension key (YES in ACT 36), the CPU 21 performs setting for continuing the job being executed until the job is completed (ACT 37). For example, as the setting for continuing the job being executed until completion, the counting of the execution time may be stopped or the time limit may be set to infinity only for the job.

If it is set to extend the execution time by predefined extension time according to the input of the forced extension key (YES in ACT 38), the CPU 21 subtracts the extension time from the count value of the execution time for the job being executed (ACT 39). When the predefined extension time is longer than the count value of the execution time, the CPU 21 only has to change the count value of the execution time to 0. Even when the predefined extension time is longer than the count value of the execution time, the CPU 21 may subtract the predefined extension time from the count value of the execution time and set the count value of the execution time to a minus value.

If it is set to receive the input of extension time according to the input of the forced extension key (YES in ACT 40), the CPU 21 receives the input of extension time by the user (ACT 39). For example, the CPU 21 receives the input of extension time by displaying an input screen for extension time on the display unit 17a. If extension time is input in this state (YES in ACT 41), the CPU 21 subtracts the input extension time from the count value of the execution time (ACT 42). When the predefined extension time is longer than the count value of the execution time, the CPU 21 may change the count value of the execution time to 0.

With the forced extension processing explained above, even when the time limit is set for the execution time of a job, the user present near the digital multi function peripheral 1 can extend the remaining time until the job being executed is switched to the next job by inputting the forced extension key on the operation panel 17.

In the explanation of the embodiment, the system control unit in the digital multi function peripheral as the image forming apparatus performs job control. However, a printing control apparatus connected to the image forming apparatus via a communication line may perform the job control.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a memory configured to store print jobs and execution sequences for forming images of the print jobs;
an image forming unit configured to form the images of the print jobs according to the execution sequences stored by the memory;
a measuring unit configured to measure execution time from start of image formation for a print job being subjected to the image formation by the image forming unit;
a first determining unit configured to determine whether plural print jobs are stored by the memory;
a second determining unit configured to determine, if plural print jobs are stored at least by the memory, whether the execution time of the print job being subjected to the image formation measured by the measuring unit reaches designated execution time; and
a job switching unit configured to suspend, after the execution time reaches the designated execution time, the printing job being subjected to the image formation and cause the image forming unit to execute a print job of a next execution sequence stored by the memory.

2. The apparatus according to claim 1, wherein
the job switching unit changes a sequence for resuming the image formation of the suspended print job to a last of the other print jobs stored by the memory, and
the memory stores the changed execution sequences.

3. The apparatus according to claim 1, further comprising:
an operation unit configured to input the designated execution time allowed as the execution time of the print job; and
a setting unit configured to set time input by the operation unit as the designated execution time.

4. The apparatus according to claim 1, wherein the measuring unit stops the measurement of the execution time for the print job being subjected to the image formation if the image forming apparatus changes to an operation stop state.

5. The apparatus according to claim 1, wherein the job switching unit prohibits, if the job being subjected to the image formation is a print job for printing a document image including plural pages, the job being subjected to the image formation from being switched to a next job in a middle of a page of the document image.

6. The apparatus according to claim 1, further comprising plural paper discharge units configured to discharge sheets on which images are formed by the image forming unit; and
a control unit configured to change, if the job switching unit switches a job, the paper discharge unit to which a sheet on which an image is formed by the image forming unit is discharged.

7. The apparatus according to claim 1, further comprising a control unit configured to insert, if the job switching unit switches a job, special paper between a sheet on which the image forming unit forms an image according to a job before the switching and a sheet on which the image forming unit forms an image according to a job after the switching.

8. The apparatus according to claim 1, further comprising a display unit configured to display remaining time until suspension of the job being subjected to the image formation and execution of a next job.

9. The apparatus according to claim 8, further comprising:
an operation unit configured to input set time for displaying the remaining time; and
a setting unit configured to set the set time input from the operation unit, wherein
the display unit displays the remaining time after the remaining time reaches the set time set by the setting unit.

10. The apparatus according to claim 1, further comprising:
an extension instruction key configured to instruct extension of remaining time until suspension of the job being subjected to the image formation and execution of a next job; and
an extension processing unit configured to extend the remaining time according to an input to the extension instruction key.

11. The apparatus according to claim 10, wherein the extension processing unit resets, according to the input to the extension instruction key, the execution time of the print job being executed measured by the measuring unit.

12. The apparatus according to claim 10, wherein the extension processing unit continues, according to the input to the extension instruction key, the print job being subjected to the image formation until the print job is completed.

13. The apparatus according to claim 10, further comprising:
an operation unit for inputting extension time for the remaining time; and
a setting unit configured to set the extension time input from the operation unit, wherein
the extension processing unit extends, according to the input to the extension instruction key, the remaining time by the extension time set by the setting unit.

14. The apparatus according to claim 10, further comprising an operation unit enabling input of extension time for the remaining time according to the input to the extension instruction key, wherein
the extension processing unit extends the remaining time by the extension time input from the operation unit.

15. A print control method comprising:
storing print jobs and execution sequences for forming images of the print jobs in a memory;
forming the images of the print jobs according to the execution sequences stored by the memory;
measuring execution time from start of image formation for a print job being subjected to the image formation;
determining whether plural print jobs are stored by the memory;
determining, if plural print jobs are stored by at least by the memory, whether the measured execution time of the print job being subjected to the image formation reaches designated execution time; and
suspending, after the execution time reaches the designated execution time, the printing job being subjected to the image formation and executing image formation for a print job of a next execution sequence stored by the memory.

16. The method according to claim 15, further comprising:
changing a sequence for resuming the image formation of the suspended print job to a last of the other print jobs stored by the memory; and
storing the changed execution sequences in the memory.

17. The method according to claim 15, further comprising stopping the measurement of the execution time for the print job being subjected to the image formation if an image forming apparatus changes to an operation stop state.

18. The method according to claim 15, further comprising prohibiting, if the job being subjected to the image formation is a print job for printing a document image including plural pages, even if measured execution time of the print job exceeds the designated execution time, the job being subjected to the image formation from being switched to a next job in a middle of a page of the document image.

19. The method according to claim 15, further comprising:
receiving input of an instruction for extending remaining time until suspension of the job being subjected to the image formation and execution of a next job; and
extending the remaining time according to the input of the instruction for extending the remaining time.

20. An image forming apparatus comprising:
storing means for storing print jobs and execution sequences for forming images of the print jobs;
image forming means for forming the images of the print jobs according to the execution sequences stored by the storing means;
measuring means for measuring execution time from start of image formation for a print job being subjected to the image formation by the image forming means;
first determining means for determining whether plural print jobs are stored by the storing means;
second determining means for determining, if plural print jobs are stored at least by the storing means, whether the execution time of the print job being subjected to the image formation measured by the measuring means reaches designated execution time; and
job switching means for suspending, after the execution time reaches the designated execution time, the printing job being subjected to the image formation and cause the image forming means to execute a print job of a next execution sequence stored by the storing means.
